(19) United States
(12) Patent Application Publication
(10) Pub. No.: US 2010/0121689 A1
(43) Pub. Date: May 13, 2010

(54) SYSTEM AND METHOD FOR WIRELESS ORDERING IN A VENUE

(76) Inventors: Collin D. Wallace, Clarksville, MD (US); Izudin Ibrahimbegovic, Duluth, GA (US); David A. Ward, Pembroke Pines, FL (US)

Correspondence Address: Craig W. Kronenthal, 1 Cuomo Ct., Millstone Twp., NJ, 08535, US

(21) Appl. No.: 12/616,776

(22) Filed: Nov. 11, 2009

Related U.S. Application Data
(60) Provisional application No. 61/193,264, filed on Nov. 12, 2008.

(51) Int. Cl. G06Q 50/00; G06Q 30/00; G06Q 10/00; G06Q 20/00; H04N 7/18

(52) U.S. Cl. 705/14.1; 705/14.5; 705/26; 705/28; 348/61; 348/E07.085

(57) ABSTRACT

The present disclosure teaches a system for wireless ordering in a venue, including a wireless communication device configured to allow a user within a venue to input information, a network that is wirelessly accessible by the wireless communication device, a server coupled to the network, and configured to transmit information packets through the network to the wireless communication device, an electronic payment gateway coupled to the server, and configured to pass electronic payment information received from the server, an order-processing computer coupled to the server, and configured to receive order information, an order-displaying device coupled to the order-processing computer, and configured to receive order information from the order-processing computer and to display the order information, and a pick-up station where customers may retrieve their orders. The present disclosure also teaches a method in accordance with the system.

### CROSS-REFERENCE TO RELATED APPLICATION

This application is related to and claims priority to U.S. Provisional Patent Application Ser. No. 61/193,264, filed Nov. 12, 2008, entitled System and Method for Wireless Ordering in Venues, the entirety of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

1. Field of the Invention

The present invention relates to a system and method for ordering items in a venue using a wireless communication device.

2. Description of Related Art

Vendors have continuously sought to increase sales through optimizing their sales process. Improving the sales process is critical in building a client base and maintaining that client base. Customers are more likely to return for future purchases if they find the sales process enjoyable. For many customers the most important aspect of the sales process is the waiting time. Customers prefer making purchases from vendors where the waiting period is short. Moreover, an efficient sales process not only benefits the customers, but leads to increased sales and greater revenue for vendors.

One of the first ways vendors sought to create a more efficient sales process was to increase the number of lines customers could wait in. While increasing the number of lines is effective, it is also costly. Increasing the number of lines requires more space, equipment, and personnel.

As advancements in technology were made other means of creating a more efficient sales process were developed. For example, the creation of the electronic cash register has improved the speed of the checkout process. More recently, self-checkout machines have been added by many vendors to decrease wait times. These self-checkout machines increase the number of lines without the added expense of additional employees, but many people have difficulty using these machines. Fax machines have also increased the speed in which customers may communicate orders to vendors. However, many people have not had access to a fax machine, while others have avoided its use because of relatively high costs.

Perhaps, the largest change to the sales process was due to the Internet. The evolution of the Internet has brought upon a whole new market of online shopping. Many vendors have created online stores for customers to view and purchase items. Customers can enter their billing information on the vendor's website and have their orders delivered to them at a location they choose. Often customers prefer buying online over going to the store because it saves the customer time otherwise used to travel to and from the store.

As familiarity with the Internet grows, so does the volume of online sales. Additionally, advancements in technology, such as the cell phone and laptop, have increased access to the Internet. These portable devices allow people to access the Internet at nearly all times and from nearly all locations. The increased access to the Internet equates to an increase in opportunities to make online purchases. Thus, many vendors have worked to capitalize on the expanding market.

Several food vendors in particular have implemented online ordering. Such vendors have provided order forms on their websites that allow customers to fill out and submit an order via the Internet. The customer can then go to the vendor and claim their order. Alternatively, some vendors offer the option to deliver the food ordered online. However, these vendors are typically located outside venues, and therefore, would not be permitted to deliver into a venue. Thus, there is a need for food service delivery inside venues.

The challenges facing vendors during heavily attended events have long been known. Given that the large majority of events held in some venues last only a few hours, it is important for vendors to make as many sales as possible in a short period of time. This goal is frustrated by the fact that those attending the event often do not wish to take their attention away from the event to make purchases. Vendors have spent considerable time and money seeking to improve their operations to increase sales.

U.S. Pat. No. 5,912,743 to Kinebuchi teaches ordering via a wireless device, but fails to solve the issue of tracking the progress of the order.

U.S. Pat. No. 6,920,431 to Showghi et al. teaches a remote ordering system and method for use in a venue. However, the '431 patent requires “identifiable delivery locations.” Given the nature of events taking place within a venue and the complexities of modern day venues, it is impractical to require identifiable delivery locations. The '439 patent makes no provision for providing alternative distribution where delivery is impractical and/or uneconomical.

U.S. Pat. No. 7,174,308 to Bergman also teaches a system for ordering items available at a venue. However, the '308 patent requires the use of a “display board” that is “simultaneously viewed by multiple venue attendees at the venue.” Thus, the '308 patent requires a costly expenditure on equipment that makes operation of the system less profitable.

Accordingly, there is a need for a practical and economically feasible system for ordering items within a venue that provides shorter wait times for customers and increased sales for vendors.

### SUMMARY OF THE INVENTION

The present invention teaches a system and method for wireless ordering in a venue. Various embodiments of the present invention are realized for providing a system and method that is suitable and economical for wireless ordering in venue.

The present disclosure teaches a system for wireless ordering in a venue, including at least one wireless communication device configured to allow a user within a venue to input information, a network that is wirelessly accessible by the at least one wireless communication device, a server coupled to the network, and configured to transmit information packets through the network to the at least one wireless communication device, an electronic payment gateway coupled to the server, and configured to pass electronic payment information received from the server, at least one order-processing computer coupled to the server, and configured to receive order information, at least one order-displaying device coupled to the at least one order-processing computer, and configured to receive order information from the at least one order-processing computer and to display the order information, and at least one pick-up station where customers may retrieve their orders.

Furthermore, the present disclosure teaches a method for wireless ordering in a venue, including an ordering step, an order-processing step wherein the information provided to the server is processed and forwarded to the wireless communication device and an appropriate order-processing computer, and a distributing step wherein the item ordered is distributed to a customer. The present disclosure also teaches that the ordering step includes an accessing step wherein a user of a wireless communication device accesses a network, an initiating step wherein a server transmits packets of information via the network to the wireless communication device, an inputting step wherein the user enters information into the wireless communication device, an approving step wherein the user approves the information previously inputted, and a submitting step wherein the user submits the information previously inputted and approved to the server.

### BRIEF DESCRIPTION OF THE DRAWINGS

A more complete understanding of the present invention, and its features and their resulting advantages, may be obtained by reference to the following detailed description when considered in light of the accompanying drawings wherein:

FIG. 1 is a schematic illustration of an embodiment of a system for wireless ordering in a venue;

FIG. 2 is a schematic illustration of another embodiment of a system for wireless ordering in a venue;

FIG. 3 is a block diagram illustrating a method for wireless ordering in a venue;

FIG. 4 is a block diagram illustrating an embodiment of an exemplary ordering step of the method for wireless ordering in a venue of FIG. 3;

FIG. 5 is a block diagram illustrating another embodiment of an exemplary ordering step of the method for wireless ordering in a venue of FIG. 3;

FIG. 6 is a block diagram illustrating an embodiment of an exemplary order-processing step of the method for wireless ordering in a venue of FIG. 3;

FIG. 7 is a block diagram illustrating an embodiment of an exemplary distributing step of the method for wireless ordering in a venue of FIG. 3;

FIG. 8 is a block diagram illustrating another embodiment of an exemplary distributing step of the method for wireless ordering in a venue of FIG. 3;

### DETAILED DESCRIPTION OF THE INVENTION

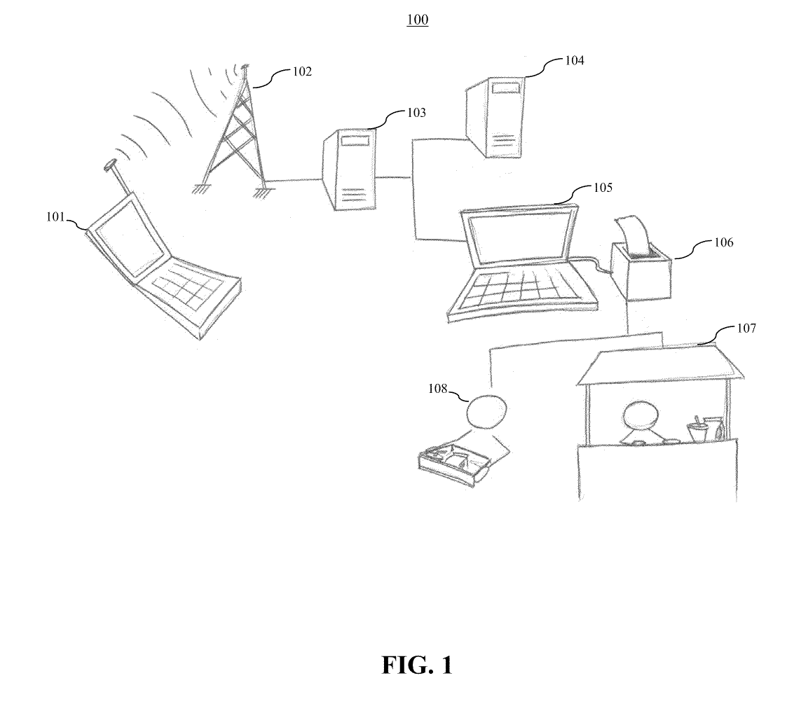

A detailed description of the invention is provided by reference to the drawing figures, in which like reference designators refer to like elements. The drawing figures are intended to allow those having ordinary skill in the art to understand the scope of the embodiments of the present invention. FIG. 1 shows a schematic of an exemplary system for wireless ordering in a venue in accordance with the principles of the present invention and designated generally as 100. The system for wireless ordering in a venue 100 allows for the ordering and distribution of items as described in the embodiments herein. Herein, item is used to refer to any good, such as food, beverages, clothing, gifts, programs, etc., or any service, such as providing a game, tour, scoreboard announcement, etc. Further, the described system for wireless ordering in a venue 100 is suitable for a variety of venues (e.g. stadium, arena, theater, etc.) hosting a variety of events (e.g. sporting event, concert, etc.), as well as, for the distribution of items to those in a local area, such as a neighborhood, campus, town, or city.

The depicted system for wireless ordering in a venue 100 includes a wireless communication device 101, a network 102, a server 103, an electronic payment gateway 104, an order-processing computer 105, an order-displaying device 106, a pick-up station 107, and a delivery person 108.

The wireless communication device 101 may be any device capable of communicating wirelessly with the network 102. An exemplary wireless communication device 101 is a cell phone, smart-phone, PDA, or laptop. Additionally, the wireless communication device 101 may be a hand-held device specifically designed to work with the network. Although all of the aforementioned wireless communication devices 101 are portable, such a feature is not necessary. For example, the wireless communication device 101 may also be fixed to a particular seat or kiosk. The only required features of a wireless communication device 101 are a display and at least one button, voice-sensor, touch screen, dial, or other device for inputting information. Note, that although only one wireless communication device 101 is shown in FIG. 1, the system for wireless ordering in a venue 100 is capable of operating with numerous and varying wireless communication devices 101.

The wireless communication device 101 may automatically access the network 102 or the customer using the wireless communication device 101 may manually access the network 102. Depending on the type of network 102, the network infrastructure may be located inside or outside the venue. The network 102 may be the Internet, a local area network (LAN), a wide area network (WAN), or any similar infrastructure having one or more transceivers. In any case, the network 102 may be accessed by numerous wireless communication devices 101 at the same time. Further, the network 102 allows the wireless communication devices 101 to be used from many different locations. In fact, the network 102 may be accessed from wherever the wireless communication device 101 can receive a network signal. Alternatively, the network 102 may be designed to limit access to those wireless communication devices 101 located within a designated area or venue.

Packets of information, including order information and billing information, may be transmitted from the wireless communication device 101 through the network 102 to the server 103. Additionally, the server 103 may transmit packets of information, including information on the price and availability of items, through the network 102 to the wireless communication device 101. Note, the server 103 may be placed at any location within the venue, or at a location outside the venue thereby permitting easier access and maintenance.

In FIG. 1, the server 103 is depicted as a single computer, but may actually comprise numerous computers acting as servers. For instance, the server 103 may represent a number of servers in a blade server arrangement. In accordance with this invention, many embodiments may be contemplated by varying the components to optimize the power, scalability, and/or reliability of the server 103. Further, the server 103 may utilize any network operating system known in the art. The server 103 also includes at least one storage device, which stores data relating to the price and availability of items offered. Although particular mention is given to the storage device, the server 103 contains all the components well known to be common in servers.

Furthermore, the server 103 allows for data collection. The server 103 may collect data pertaining to the number of sales, the specific items sold, the time at which items are sold, to whom they were sold, etc. This data may then be compared with past data collected, processed to determine meaningful projections, and/or provided to the vendor or others interested in such sales data. The server 103 is also capable of storing this data for later review, so that inventory and operations may be improved as well. The server's 103 ability to collect data is important to the economic viability of the system for wireless ordering in venues 100.

As shown in FIG. 1, the server 103 is coupled to both the electronic payment gateway 104 and the order-processing computer 105. The connections between the server 103 and the electronic payment gateway 104 and between the server 103 and the order-processing computer 105 may be either wired or wireless. Further, the connections can, but do not need to be, of the same type (i.e., one connection may be wired and the other connection may be wireless). The server 103 processes the information packets sent from the wireless communication devices 101 via the network 102, and provides the appropriate information to either the electronic payment gateway 104 or order-processing computer 105.

The electronic payment gateway 104 may be any gateway designed to pass billing information to a bank, credit card company, or other financial service. The electronic payment gateway 104 may pass packets of information that contain debit card information, credit card information, check information, or any information pertaining to electronic payment. In addition to receiving billing information, the electronic payment gateway 104 may also transmit information confirming payment.

FIG. 1 shows only one order-processing computer 105, but the system for wireless ordering in venues 100 may have numerous order-processing computers 105 at different locations. The order-processing computer 105 is located at the vendor's location. Further, each order-processing computer 105 may be designed to best suite the operations that are performed at that particular vendor. In other words, one order-processing computer 105 may run a particular application that is better suited for processing orders where the items are food, while another order-processing computer 105 may run another application better suited for processing orders where the items are souvenirs.

Additional advantages may be realized by placing the order-processing computer 105 at the vendor's location, which is at a location separate from the customer's location, but within the same venue as the customer. Locating the order-processing computer 105 at the vendor's location allows the vendors in charge of distributing the ordered items to access the order-processing computer 105. Vendors may access the order-processing computer 105 to view the order or perform functions to the order, such as changing the status of an order or canceling an order. Moreover, vendors may use the order-processing computer 105 to communicate item availability or price changes to the server 103, and therefore, to customers using a wireless communication device 101. Furthermore, the order-processing computer 105 allows for data collection. The order-processing computer 105 may collect data pertaining to the number of sales, the specific items sold, the time at which items are sold, etc. This data may then be compared with past data collected, processed to determine meaningful projections, and/or provided to the vendor. Providing such real-time projections can help vendors improve service and profits. The order-processing computer 105 is also capable of storing this data for later review, so that inventory and operations may be improved as well. The order-processing computer's 105 ability to collect data is important to the economic viability of the system for wireless ordering in venues 100.

The order-displaying device 106 may be any device capable of outputting a display of the order. For example, the order-displaying device 106 may be a printer that prints a receipt or a double ticket (which is essentially two receipts—one for the vendor and one for the customer). In another embodiment, the order-displaying device 106 may be a screen that displays the order. The order-displaying device may be located at the same site as the order-processing computer 105 or at a separate location where the items are distributed. Placing the order-displaying device 106 at a separate location from the order-processing computer 105, allows the pick-up station 107 and delivery person 108 to operate from a separate location thereby reducing confusion and congestion at the vendor's location.

The pick-up station 107 is a designated physical space where customers may retrieve the items they have ordered. The pick-up station 107 may be a portion of the space at the vendor's location. Alternatively, the pick-up station may be at a separate location within the venue thereby reducing confusion and congestion at the vendor's location. Moreover, a pick-up station 107 may be at a separate location that is closer to the customers. In one embodiment, each vendor has its own pick-up station 107. In such circumstances, a venue with numerous vendors would have an equal number of pick-up stations 107. However, in another embodiment, multiple vendors may share a single pick-up station 107. In some venues, where space is limited, this arrangement may be necessary.

By providing a pick-up station 107, the system for wireless ordering in a venue 100 advantageously reduces the wait for customers allowing them to spend their time viewing the events taking place at the venue. Reducing the time a customer waits in line increases sales at a venue. Further, many customers are deterred from ordering items to be delivered because of customary delivery tips. Thus, offering a customer an alternative to delivery also acts to increase sales. Note, the increase in sales resulting from the pick-up station 107 is important to the economic viability of the system for wireless ordering in a venue 100.

FIG. 1 also shows a delivery person. The delivery person 108 is responsible for taking the items ordered to the customer at the location provided by the customer. Upon delivering the ordered items, the delivery person may collect the payment or authorize an electronic payment.

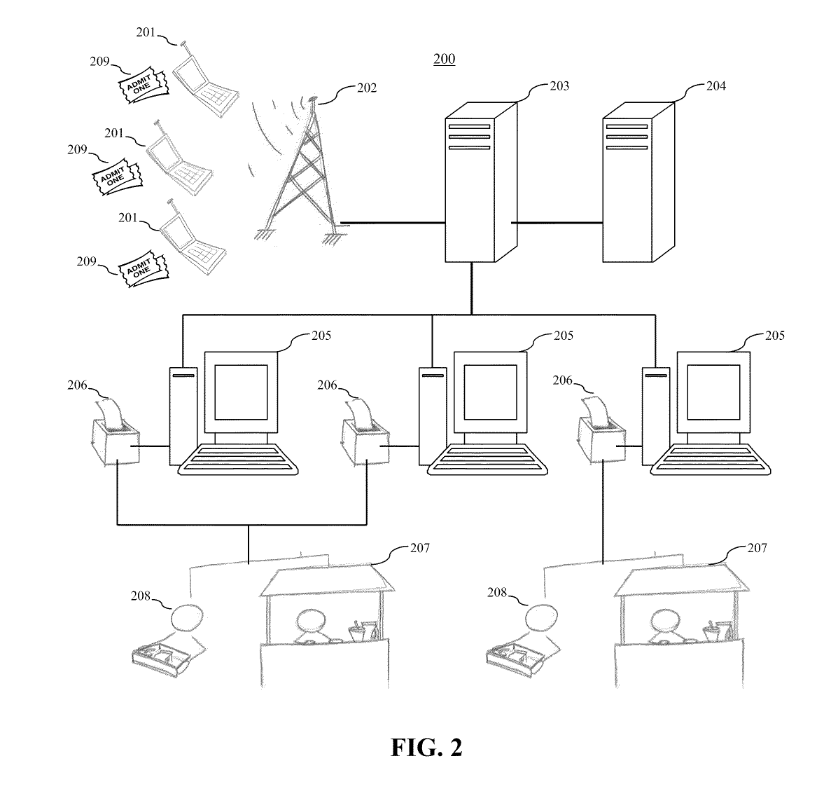

FIG. 2 is a schematic illustration of another embodiment of a system for wireless ordering in a venue. The depicted system for wireless ordering in a venue 200 includes tickets 209, wireless communication devices 201, a network 202, a server 203, an electronic payment gateway 204, order-processing computers 205, order-displaying devices 206, pick-up stations 207, and delivery persons 208.

The tickets 209 are those used by customers to gain entry into a venue. Each customer must have a ticket 209 to gain entry into the venue. The tickets 209 may contain information on the customer's location, including a venue, a section, a row, and/or a seat, or it may contain promotional material. The tickets 209 may also contain information, including a web site address, or directions explaining how a customer can access and use the system for wireless ordering in a venue.

Additionally, the ticket 209 may contain a bar code. The bar code can contain the customer's location or promotional information. For example, the bar code may contain information indicating that a certain item is offered at a sale price. In this manner, the ticket 209 becomes a marketing tool, helping to entice customers to access the system 200. A customer may use a wireless communication device 201 having a camera to take a picture of the bar code on the ticket 209. The customer may then transmit the picture of the bar code to the server 203, which can read the bar code and determine its information. Where the bar code contains promotional material, the server 203 transmits information back to the wireless communication device 201 conveying the promotional offer. Where the bar code contains location information, the server 203 transmits information back to the wireless communication device 201 conveying the items available for the customer's particular venue and/or location.

FIG. 2 depicts a plurality of wireless communication devices 201. The system for wireless ordering in a venue 200 permits numerous wireless communication devices 201 to access the network 202 at the same time.

FIG. 2 also shows numerous order-processing computers 205 each coupled to the server 203. Each order-processing computer 205 is located at a different vendor within the venue. Each order-processing computer 205 is also coupled to an order-displaying device 206, such as a printer for printing a receipt. Also, although not shown in FIG. 2, multiple order-processing computers 205 may be coupled to the same order-displaying device 206. For example, one order-displaying device 206, located at a pick-up station 207, may receive orders from multiple order-processing computers 205, thereby allowing multiple vendors to share a single pick-up station 207.

Furthermore, each order-displaying device 206 is displayed at a pick-up station 207 or to a delivery person 208. The order-displaying device 206 displays the order to a vendor at a pick-up station 207 or to a delivery person 208, so that the vendor or delivery person may prepare the order. Note, that multiple order-displaying devices 206 may share the same pick-up station 207 and/or delivery persons 208, as is shown in FIG. 2.

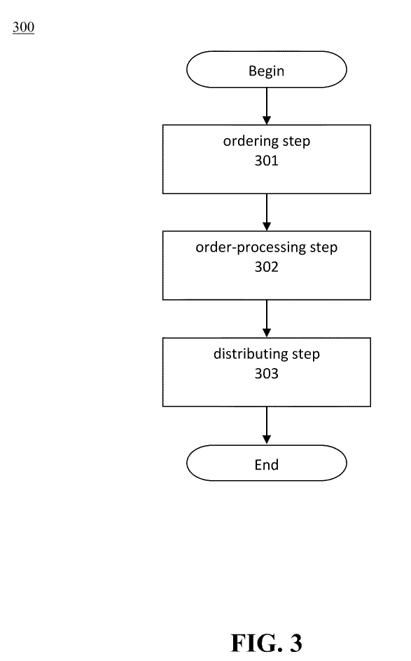

FIG. 3 shows one embodiment of a method for wireless ordering in a venue 300. This method has three main steps: an ordering step 301, an order-processing step 302, and a distributing step 303. The ordering step 301 signifies the first step taken when a customer orders an item from the system depicted in FIG. 1. This is the step in which the customer inputs an order using a wireless communication device 101. The details of this step will be described in more detail below. After completion of the ordering step 301, the order-processing step 302 automatically begins. The details of this step will also be described in more detail below. Finally, the method is complete when the distributing step 303 is performed. Again, this step will be described in more detail below.

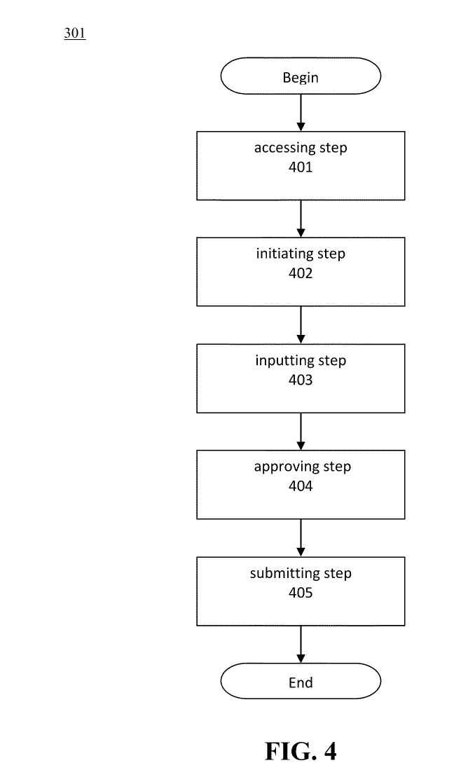

FIG. 4 illustrates one embodiment of the ordering step 301 of the method for wireless ordering in a venue 100. In this particular embodiment, the ordering step 301 includes an accessing step 401, an initiating step 402, an inputting step 403, an approving step 404, and a submitting step 405. The accessing step 401 is the step wherein the wireless communication device 101 accesses the server 103 via the network 102. The accessing step 401 may be performed by launching an application installed on the wireless communication device 101 that may automatically access the server 103. Alternatively, the accessing step 401 may be performed when a user manually directs the wireless communication device 101 to access the server 103.

Completion of the accessing step 401 triggers the initiating step 402. The initiating step 302 initiates the display on the wireless communication device 101 according to the information stored on the server 103. The server 103 is capable of determining the venue or location of the communication device 101 based on GPS signals, cell phone signals, or a manual entry/selection. Therefore, in the initiating step 402, the server 103 sends data based on the venue or location of the communication device 101. The data provided in the initiating step 402 includes graphics, item information, advertisements, and promotions.

The initiating step 402 provides numerous advantages. First, the server 103 is capable of sending data based on capacity to serve or availability. In other words, the server 103 may provide data so that only the items that are currently available are displayed to the user of the wireless communication device 101. Such a feature is critical in venues where restrictions on the sale of items (e.g. alcoholic beverages) are in place. This feature allows the vendor to avoid the situation in which a customer orders an item that later becomes unavailable thereby improving customer satisfaction. This feature also permits the vendor to change prices according to the availability of items thereby increasing sales and reducing waste. Second, the initiating step 402 allows specific advertisements to be sent to the wireless communication device 101. In this manner, the advertisements may be tailored to the audience and displayed at strategic times. In one embodiment, the initiating step allows the server 103 to push advertisements onto the wireless communication devices 101 that have previously accessed the system. For example, the server 103 may send data pertaining to a new item offered or a discounted item, without the wireless communication device 101 requesting the data. Each of these advantages is important to the economic viability of the system.

The initiating step 402 is followed by the inputting step 403. The inputting step 403 is the step in which the user of the wireless communication device 101 inputs order information including the type, size, and quantity of an item desired. In the inputting step 403 the user may also input location information and delivery method information if necessary. Note that the customer location information may be the location of another individual. Thus, it is possible to use the method of wireless ordering in a venue 300 to make a gift. In one particular embodiment, the inputting step 403 allows the customer to see other users of the system for wireless ordering in a venue 100, so that the customer may send items to another user without knowing the user's location. Further, in the inputting step 403 the user also inputs billing information. Alternatively, the billing information may be automatically filled based on a customer profile stored either locally on the wireless communication device 101 or on the server 103. Such billing information may include the information necessary to make an electronic payment or may be an indication that the customer will pay in cash.

The inputting step 403 may be performed by typing, selecting a button such as a radio button, selecting from a drop down menu, clicking and dragging an icon, speaking into the wireless communication device 101, or performing any combination of such actions. Moreover, the inputting step 403 allows the user to input an image of a bar code. The image may be any digital image stored in any format and taken with any digital camera, such as the camera on a phone. Further, the bar code may be provided on any substance, such as promotional material or a ticket.

After the inputting step 403, all of the inputted information is displayed back to the user in a step called the approving step 404. In this step, the user is required to confirm/approve all of the inputted information. If the user does not wish to confirm/approve the order, the user has the option to go back and edit the input information.

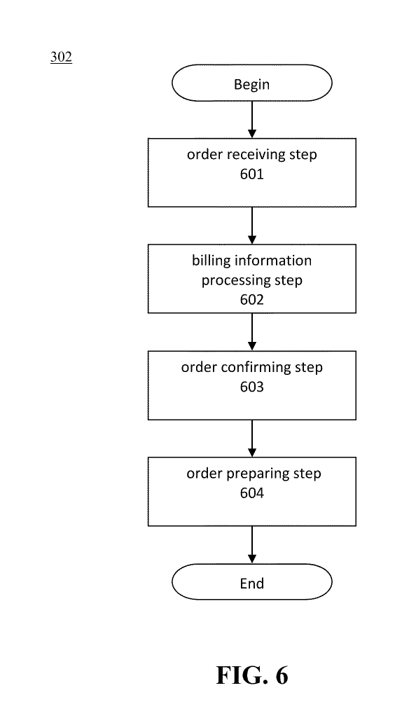

Once the inputted information is approved, the method enters into the submitting step 405. In the submitting step 405, all of the inputted information is sent to the server 103 and the order-processing step 302 begins. The details of the order-processing step 302 will be discussed below with reference to FIG. 6.

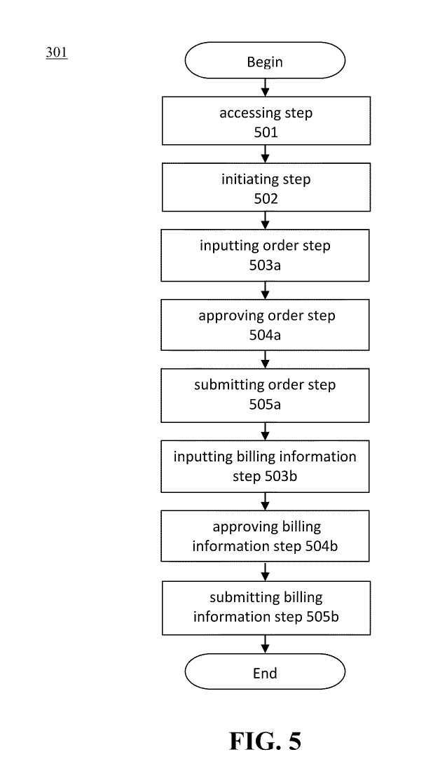

FIG. 5 illustrates a second exemplary embodiment of the ordering step 301 of the method for wireless ordering in a venue 300. In this second embodiment the ordering step 301 includes an accessing step 501, an initiating step 502, an inputting order step 503a, an approving order step 504a, a submitting order step 505a, an inputting billing information step 503b, an approving billing information step 504b, and a submitting billing information step 505b. The accessing step 501 and initiating step 502 are similar to the accessing step 401 and initiating step 402 described in reference to FIG. 4.

The inputting order step 503a, approving order step 504a, and submitting order step 505a are similar to the inputting step 403, approving step 404, and submitting step 405, respectively, except that in each of steps 503a, 504a, and 505a only order information is handled. Order information includes item information and customer location information. The item information may include the item name/description, size, quantity, color, serial number, etc. The customer location information includes numbers, letters, alphanumeric codes, colors, and/or any other indicia for indicating a customer's location. For example, the customer information may include a number indicating the section, a letter indicating the row, and another number indicating the seat.

The inputting billing information step 503b, approving billing information step 504b, and submitting billing information step 505b are similar to the inputting step 403, approving step 404, and submitting step 405, respectively, except that in each of steps 503b, 504b, and 505b only billing information is handled. Recall that billing information includes the information necessary to make an electronic payment or may be an indication that the customer will pay in cash.

Thus, the ordering step 301 of the embodiment shown in FIG. 5 differs from the ordering step 301 of the embodiment shown in FIG. 4 because the order information is sent to the server 103 before the billing information is ever inputted. The advantage of the embodiment of the ordering step 301 shown in FIG. 5 is that the server 103 may determine if a particular item is available before the billing information is inputted. If the item ordered is not available then the customer does not have to enter the billing information. Therefore, the embodiment shown in FIG. 5 can help reduce customer frustration by avoiding the situation in which the customer needlessly enters billing information when the item is not available.

FIG. 6 illustrates one embodiment of the order-processing step 302 of the method for wireless ordering in a venue 300. In this particular embodiment, the order-processing step 302 includes an order receiving step 601, a billing information processing step 602, an order confirming step 603, and an order preparing step 604. The order receiving step 601 is the step in which the information submitted by the wireless communication device 101 in the ordering step 301 is received by the server 103.

Next, the server 103 begins the billing information processing step 602. In this step, the server 103 determines whether the user has chosen to make an electronic payment or to pay with cash. If the user chose to make an electronic payment, then the billing information is forwarded to the electronic payment gateway 104. The billing information may be forwarded immediately, or temporarily stored and forward later when items are distributed. Where the billing information is immediately forwarded the order-processing step 302 is stopped and the user is notified if the payment is not approved.

Additionally, in the billing information processing step 602, the server 103 calculates the total amount owed. In calculating the total, the server 103 applies promotions and discounts. For example, in one embodiment the server 103 may analyze an image of a bar code to apply a discount.

The order confirming step 603 sends an order confirmation to the wireless communication device 101 and the appropriate order-processing computer 105 simultaneously. In one embodiment, the order confirmation is then automatically forwarded to the order-displaying device 106. The order confirmation may include the item name, item description, item amount, item quantity, item size, customer location, a confirmation code, estimated delivery or pick-up time, directions to a pick-up station 107, a map of the venue showing a pick-up station 107, and/or instructions on what to do if there are problems with the order. The estimated delivery or pick-up time is calculated by the server 103 or order-processing computer 105 as part of the order confirming step 603. This calculation is based on the number of orders in the queue and whether the order is for pick-up or delivery. Additionally, the order confirming step 603 determines the appropriate pick-up station 107 for the order. In one embodiment, numerous pick-up stations 107 may be capable of supplying the ordered items. In such an embodiment, the server 103 in the order confirming step 603 determines which pick-up station 107 should be used for the particular order. The appropriate pick-up station 107 may be determined based on location with respect to the customer, item availability, and/or wait time at each pick-up station 107.

Finally, the order preparing step 604 is performed. In one embodiment of the order preparing step 604, the vendor takes the receipt printed from the order displaying device 106 and prepares the order according to the receipt. Preparing the order may include cooking the item and/or packaging the item. This may be done at the pick-up station 107 or at another location by delivery personnel 108. In another embodiment, the order displaying device 106 is a screen on which the order confirmation is displayed. In such an embodiment, the vendor may use the order-processing computer 105 to track the progress of preparing the order. For example, the vendor may use the order-processing computer 105 to change the status of an order to reflect when preparation of the order is complete.

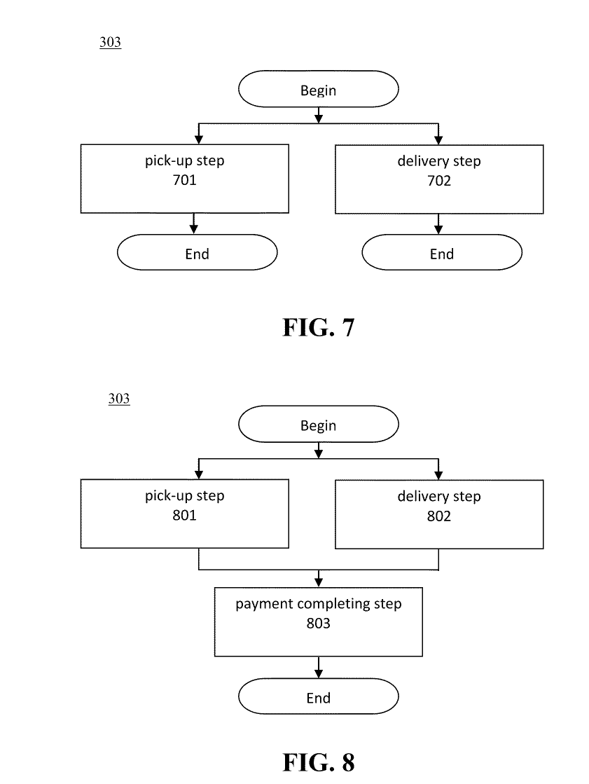

FIG. 7 illustrates one embodiment of the distributing step 303 of the method for wireless ordering in a venue 300. The distributing step 303 may be performed by either the pick-up step 701 or the delivery step 702 depending on the method requested by the customer. In the pick-up step 701, the customer presents order information, such as the confirmation code, to a vendor employee at the pick-up station 107 to claim the item. In the delivery step 702, a vendor employee or delivery person 108 takes the item to the customer at the designated customer location. Thus, in both the pick-up step 701 and delivery step 702, the item is distributed to the customer and the order is completed.

FIG. 8 illustrates another embodiment of the distributing step 303 of the method for wireless ordering in a venue 300. The distributing step 303 of this embodiment includes a pick-up step 801 and a delivery step 802 that are the same as the pick-up step 701 and delivery step 702, respectively, described above. In the embodiment of the distributing step 303 shown in FIG. 8, however, an additional step exists. As shown in FIG. 8, the pick-up step 801 and delivery step 802 are followed by a payment completing step 803. In the payment completing step 803, a vendor employee records that the customer has received the item. A record may be made by having the customer sign a receipt or by making an entry into the order-processing computer 105. Further, where the customer chooses to make an electronic payment, the payment completing step 803 may be the step in which the server 103 is directed to send the billing information to the electronic payment gateway 104. By withholding the billing information in the server 103 until the item is distributed to the customer, the vendor can avoid having to correct charges for undelivered items or mistakenly delivered items. This feature not only reduces the vendor's workload, but it also helps to avoid the hassle a customer feels thereby improving customer satisfaction with the system for wireless ordering in a venue 100.

While the present invention has been described with reference to the drawing figures, a person having ordinary skill in the art would recognize that various modifications may be made without departing from the scope and spirit of the invention.

What is claimed is:

1. A system for wireless ordering in a venue, comprising:
at least one wireless communication device configured to allow a user within a venue to input information;
a network that is wirelessly accessible by the at least one wireless communication device;
a server coupled to the network, and configured to transmit information packets through the network to the at least one wireless communication device;
an electronic payment gateway coupled to the server, and configured to pass electronic payment information received from the server;
at least one order-processing computer coupled to the server, and configured to receive order information;
at least one order-displaying device coupled to the at least one order-processing computer, and configured to receive order information from the at least one order-processing computer and to display the order information; and
at least one pick-up station where customers may retrieve their orders.

2. The system of claim 1, wherein the at least one wireless communication device is a cell phone, smart phone, PDA, or laptop computer.

3. The system of claim 1, wherein the network is the Internet or a local area network.

4. The system of claim 1, wherein the server further comprises:
a storage device, which stores data relating to the price and availability of items offered.

5. The system of claim 4, wherein the server is located outside the venue.

6. The system of claim 5, wherein the information packets transmitted by the server contain information regarding item prices, item availability, or advertisements.

7. The system of claim 1, wherein the at least one order-processing computer is located at a vendor location within the venue.

8. The system of claim 1, wherein the at least one order-displaying device is a printer configured to print a receipt or a double ticket.

9. The system of claim 1, wherein the at least one pick-up station is a portion of the space at a vendor location.

10. The system of claim 1, wherein the at least one pick-up station is at a separate location from a vendor's location.

11. The system of claim 10, wherein the at least one order-displaying device is located at the at least one pick-up station.

12. The system of claim 11, wherein the at least one order-displaying device is coupled to at least two order-processing computers.

13. The system of claim 1, further comprising:
at least one ticket used by the user to gain entry to the venue.

14. The system of claim 13, wherein the ticket displays directions on how to access the system.

15. The system of claim 13, wherein the ticket displays a bar code, which contains information pertaining to a customer's location.

16. The system of claim 15, wherein the at least one wireless communication device includes a camera for taking a picture of the bar code, and the server includes a device for reading the bar code from the picture to obtain the information contained within the bar code.

17. The system of claim 13, wherein the ticket displays a bar code, which contains information pertaining to a promotion.

18. The system of claim 17, wherein the at least one wireless communication device includes a camera for taking a picture of the bar code, and the server includes a device for reading the bar code from the picture to obtain the information contained within the bar code.

19. A method for wireless ordering in a venue, comprising:
an ordering step further comprising an accessing step wherein a user of a wireless communication device accesses a network, an initiating step wherein a server transmits packets of information via the network to the wireless communication device, an inputting step wherein the user enters information into the wireless communication device, an approving step wherein the user approves the information previously inputted, and a submitting step wherein the user submits the information previously inputted and approved to the server;
an order-processing step wherein the information provided to the server is processed and forwarded to the wireless communication device and an appropriate order-processing computer; and
a distributing step wherein the item ordered is distributed to a customer.

20. The method of claim 19, wherein the initiating step renders a display on the wireless communication device in accordance with the transmitted packets of information.

21. The method of claim 20, wherein the initiating step transmits packets of information based on a capacity to serve or availability.

22. The method of claim 21, wherein the capacity to serve and availability are determined by previous orders.

23. The method of claim 21, wherein the capacity to serve and availability are determined based on data input by a vendor via an order-processing computer.

24. The method of claim 21, wherein the capacity and availability are pre-determined by an authorized user of the server.

25. The method of claim 19, wherein the initiating step transmits the packets of information in response to completing the accessing step.

26. The method of claim 19, wherein the initiating step transmits the packets of information in response to a command given by an authorized user of the server.

27. The method of claim 26, wherein the server uses the connection with a wireless communication device established in a previously completed accessing step, to transmit the packets of information that are displayed on the wireless communication device.

28. The method of claim 27, wherein the packets of information include advertisements.

29. The method of claim 19, wherein the initiating step transmits the packets of information in response to a command given by a vendor via an order-processing computer coupled to the server.

30. The method of claim 19, wherein the distributing step further comprises:
a pick-up step in which the customer goes to a designated pickup station and an employee at the pick-up station distributes the item to the customer; and
a payment completing step in which an electronic payment is completed by accessing the server and forwarding billing information to an electronic payment gateway after the employee distributing the item verifies that the item was distributed.
